(19) United States
(12) Patent Application Publication
(10) Pub. No.: US 2008/0243618 A1
(43) Pub. Date: Oct. 2, 2008

(54) METHOD OF ORGANIZING CONSUMERS IN THE DISCOUNTED RETAIL PURCHASE OF GOODS OR SERVICES

(76) Inventors: Claudio PANOZZO, ZANE' (VI) (IT); Emanuele SERAFIN, CALTRANO (VI) (IT)

Correspondence Address: CASTELLANO PLLC, P.O. Box 1555, Great Falls, VA, 22066, US

(21) Appl. No.: 12/058,658

(22) Filed: Mar. 28, 2008

(30) Foreign Application Priority Data
Apr. 2, 2007 (IT) PD2007A000120

(51) Int. Cl. G06Q 30/00

(52) U.S. Cl. 705/14

(57) ABSTRACT

A method of organizing consumers in the discounted retail purchase of goods or services comprises the steps of forming an Organizational Structure which a plurality of consumers can join and establishing with at least one point of sale of goods or services, by means of the Structure, a discount percentage to be given to the member consumers for the purchase of at least one of the goods or services so as to facilitate the purchase thereof by some of the consumers at the point of sale. According to this method, membership of the Organizational Structure is free for the plurality of consumers and the points of sale provide the Structure with a monetary fee on the basis of the sale of the goods or services to the plurality of member consumers.

### FIELD

The present invention relates to a method of organizing consumers in the discounted retail purchase of goods or services.

### BACKGROUND

In wholly general terms, in the conventional market model developed in western commercial society, when a large number of consumers need to make a retail purchase of an item or service, they individually and independently establish a contractual relationship with one or more points of sale which are able to offer the item or service in question. Naturally, in this situation, the negotiating power of the individual consumer is somewhat limited and he is at such an objective disadvantage with respect to the point of sale that the everyday reality, especially at points of sale of some size, is that the selling prices as well as the offers and discounts made are not the result of free negotiation between the parties but rather are decided and fixed by the point of sale; in this situation, the consumer normally has the option purely to accept the conditions proposed or not.

Consumer groups of a more or less structured nature have emerged in order to increase consumers' negotiating power with respect to one or more points of sale and thus to achieve forms of discount on selling prices of goods or services.

The most common types of organization provide for consumers to belong to an association or cooperative; all of these organizations will be defined generically in this context by the term “Organizational Structure”; the “Structure” provides for a series of contracts to be entered into with a number of points of sale in order to fix a discount percentage on the purchase prices of predetermined goods or services which the consumers belonging to the “Structure” can enjoy. The advantages connected with groups of this type are determined, on the one hand, by the discounts to which the consumers have access by virtue of their membership of the Organizational Structure and, on the other hand, by the establishment of customer loyalty which enables the agreed deal to be obtained. Examples of organizations of this type are represented by some consumer associations or by associations of a specific nature such as sports or cultural associations which negotiate favourable financial conditions for their members with some commercial concerns.

However, organizations of this type have some disadvantages which limit their spread and efficiency. A first of these disadvantages is that membership of these Organizational Structures involves at least a financial burden to be borne by the consumer which, for more hesitant consumers, often constitutes a factor dissuading them from joining. Moreover, the consumer tends to feel “forced” to make purchases from contracting businesses in order to recoup the costs sustained for membership of the Structure.

There are also other known types of organization which provide for the formation of a kind of cooperative between, for example, people living in the same building or in the same district, in order to negotiate favourable prices with some specific point of sale. However, these Organizational Structures are necessarily limited in the number of members and the purchases often have to be made wholesale, resulting in organizational burdens owing to the need to collect the requirements of the member consumers and then to divide the goods purchased between them.

### SUMMARY

The object of the present invention is to provide a method of organizing consumers in the discounted retail purchase of goods or services which overcomes the limitations discussed above.

This object is achieved by the present invention by means of a method of organizing consumers implemented in accordance with the appended claims.

### BRIEF DESCRIPTION OF THE DRAWINGS

The characteristics and the advantages of the invention will become clearer from the detailed description of a preferred embodiment thereof which is described by way of non-limiting example with reference to the appended drawings, in which:

FIG. 1 is a diagram representing the conventional relationship between consumers and points of sale, and

FIG. 2 is a diagram representing the relationship between consumers and points of sale that is achieved by the method according to the invention.

### DETAILED DESCRIPTION

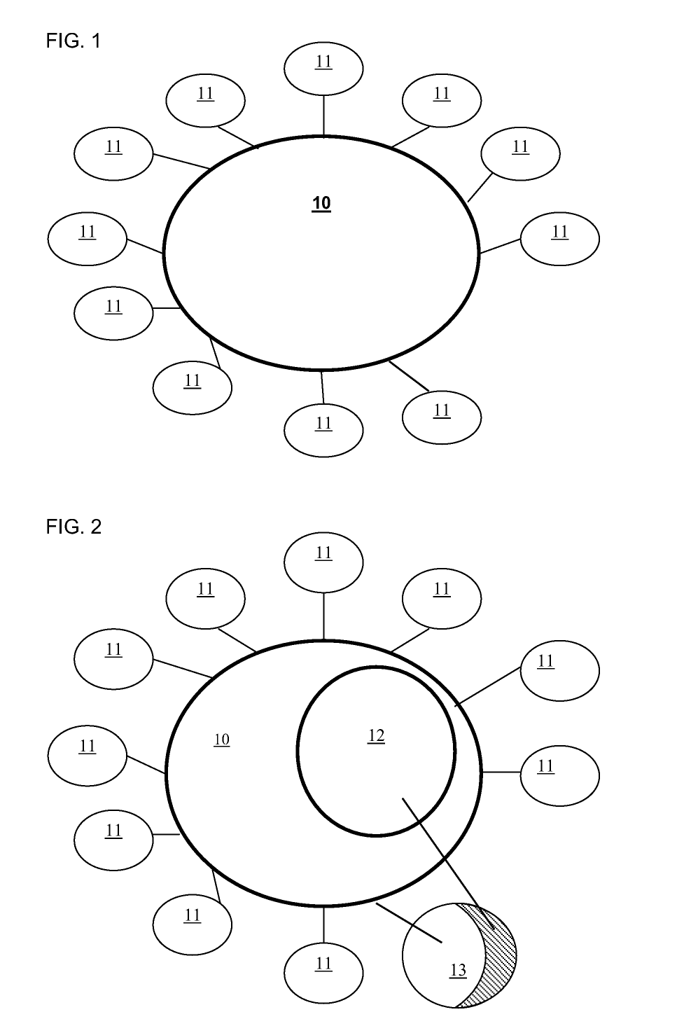

FIG. 1 shows schematically the conventional market relationship between consumers 10 and points of sale of goods or services, all indicated 11. In this model, the limitations of which have already been described briefly in the introductory part of the description, the consumers act substantially independently of one another to establish the market relationships which are most advantageous and which best respond to their own needs, giving rise to a dynamic equilibrium in which a certain number of different consumers will be associable with each point of sale.

The method proposed by the present invention proposes to group together the largest possible number of consumers so as to be able to negotiate the largest possible discounts with each point of sale precisely by virtue of the large number of potential customers.

In order advantageously to address and manage the necessary negotiations with the points of sale and the other necessary tasks, such as the registration of consumers, it is proposed to create a dedicated Organizational Structure, for example, in the form of an intermediary association.

According to a principal characteristic of the method according to the invention, membership of the Structure will be completely free for the consumers except, at most, for the cost of a means of recognition which indicates the consumer's membership of the Structure.

No other burden, constraint or obligation will be imposed on the consumer joining the association so that he will not even partially have to give up his complete freedom to purchase or not to purchase an item or a service or to purchase it at one point of sale rather than at another. Any barrier to the consumers' admission to the Structure is thus removed, facilitating to the greatest possible extent the membership of a large number of consumers and building up the negotiating strength of the Organizational Structure.

Joining preferably consists of the registration of the consumer concerned and the consequent issuing by the Structure of a means of recognition, preferably of the magnetic card type, which will be used by the consumer at the time of purchase, as explained in detail below.

In view of the fact that the greater negotiating strength of the Structure depends on the number of consumers belonging to it, the consumer membership campaign will be advertized appropriately by every suitable means, for example, in the press, on television, on the internet by leafleting, etc.

Procedures for collaboration with third-party associations such as cultural associations, trade unions, or the like are also provided for; for these, the Structure may recognize a proportion of the income of the Structure resulting from the purchases made by the consumers who also belong to such third-party associations.

By virtue of the number of actual and potential members, the Organizational Structure will enter into a series of contracts with the largest possible number of points of sale in order to agree with them a percentage discount to be given to the consumers belonging to the Structure on one or, preferably, more goods or services offered by the point of sale in question.

It is pointed out that the point of sale may be a commercial concern of any type which can offer goods or services upon payment, including concerns which operate preferably, or even exclusively, on the internet.

In fact the points of sale that have entered into agreements with the Structure preferably range across the most diverse market sectors from food to clothing, to restaurants, to skilled and professional services, to pharmacies, to credit and/or insurance institutions, to furnishings, to large-scale distribution, and even to gymnasia, vehicle workshops, or dentists. In theory, there are no exclusions to the establishment of contracts with any supplier of services or goods.

Moreover, within each market sector, contracts will preferably entered into with points of sale of different qualitative levels so as to satisfy consumers of every type.

In addition to the quantification of the discount percentage, the negotiation with the point of sale also provides for the quantification of a monetary maintenance fee which the point of sale will pay, for example, monthly, to the Organizational Structure.

In particular, the fee will be established according to the income received by the point of sale as a result of purchases made by consumers belonging to the Structure.

This fee should more preferably be established as a percentage of the increased number of goods/services sold by the point of sale as a result of the purchases made by member consumers.

In this latter case, it will be useful to define, during negotiations between the Structure and the point of sale, a reference number of goods/services, understood as the average number sold by the point of sale within a predetermined period of time prior to entering into the contract with the Structure.

It will be appreciated that the point of sale thus has sufficient guarantee that its own financial contribution to the Structure is made solely with respect to the increased income which is actually attributable to its entering into the contract with the Structure.

Naturally, the method according to the present invention provides for each member consumer to be sent a detailed list of the points of sale which have established a contract with the Structure and, for each point of sale, the goods/services on which a discount is given and, naturally, the size of the discount. There is no obligation or constraint on the consumer to make his purchases at a point of sale that has entered into a contract but, by virtue of the discounts which can be enjoyed at those points of sale, the member consumer will prefer to get his supplies from them.

A net increase in the number of consumers acquired by the point of sale can consequently be expected, with a corresponding net increase in profits.

This situation is shown schematically in appended FIG. 2 in which a group of consumers 12 belonging to the Structure is formed within the body of consumers 10. The group 12 will preferably be persuaded to obtain goods or services from a contracting point of sale 13 rather than from the remaining points of sale 11, thus leading to the acquisition of a new group of purchasers 14 by the contracting point of sale 13.

In detail, the method of purchase is as follows.

When purchasing an item or a service from a contracting point of sale, the consumer will supply the vendor with his magnetic recognition card so that the purchase of the item/service will be duly recorded by the vendor.

In a preferred procedure, the consumer may pay for the item/service by normal payment means (cash, cheque, debit or credit card) with immediate deduction of the discount previously agreed between the point of sale and the Structure for each of the goods/services which are subjects of the contract.

Alternatively, the member consumer may pay the full price for the item/service and the Structure may then partially reimburse the member consumer, for example, by means of periodic bank transfers or by direct reimbursement at credit institutions. In a variant of the method, the member consumer will be reimbursed with shopping vouchers for use at agreed points of sale.

In a further embodiment of the invention, the Structure will issue member consumers with a magnetic card on which an amount prepaid by the consumer directly to the Organizational Structure is recorded in addition to the consumer recognition elements. In this case, it will not be necessary to use cash or other payment means at the time of purchase, but the cost of the goods/services purchased by the consumer, duly discounted as agreed with the Structure, will be deducted directly from the prepaid sum. The sum can be topped up successively in the most convenient ways, for example, by bank transfers or directly with the Structure.

The Organizational Structure will provide the points of sale with means for reading the member consumers' magnetic cards, for use in recording purchases. Moreover, the Structure will have the necessary data-processing means which enable information relating to the purchases made to be received from the contracting points of sale so as to be able to determine the size of the fee due to the Structure from the point of sale and, if necessary, the amount to be reimbursed to the member consumer.

The implementation of the method of the present invention affords many advantages both for the consumers and for the contracting points of sale.

Amongst the advantages for consumers are, in particular, immediate savings on the prices of goods and services, saving of time in the search for a suitable point of sale, and complete freedom from financial burdens and obligations with respect to the Structure.

Amongst the advantages for the agreed points of sale are the increase in the customer portfolio, customer loyalty, the increase in the volume of business, as well as considerable indirect publicity.

1. A method of organizing consumers in the discounted retail purchase of goods or services, comprising the steps of:
forming an Organizational Structure which a plurality of consumers can join,
establishing with at least one point of sale of the goods or services, by means of the Structure, a discount percentage to be given to the plurality of member consumers for the purchase of at least one of the goods or services so as to facilitate the purchase of the goods or services by some of the member consumers at the point of sale,
wherein the membership of the Organizational Structure is free for the plurality of consumers, and the at least one point of sale provides the Structure with a monetary fee on the basis of the sale of the goods or services to the plurality of member consumers.

2. A method according to claim 1 wherein the monetary fee is established on the basis of a percentage of the income from which the at least one point of sale has benefited as a result of the purchases made by the plurality of member consumers.

3. A method according to claim 2 wherein the monetary fee is established on the basis of a percentage of the income resulting from the greater number of goods or services sold by the point of sale with respect to a predetermined historical value preceding the contract of the sales point with the Structure for the discount percentage to be applied to the goods or services.

4. A method according to claim 1 wherein each purchase of the goods or services made by the member consumers is recorded at the at least one point of sale by means of a personal magnetic card issued by the Organizational Structure to the member consumers.

5. A method according to claim 4 wherein, after the recording, the consumers can pay for the item or service directly in discounted form, as established between the Structure and the point of sale.

6. A method according to claim 4 wherein, after the recording, the consumers pay for the item or service in full and are reimbursed periodically by the Organizational Structure with the amounts resulting from the discounts made by the at least one point of sale.

7. A method according to claim 4 wherein an amount prepaid by the consumer is recorded on the magnetic card by the Structure and the cost of the purchase of the good or service is deducted from that amount.

8. A method according to claim 1, wherein the Structure provides the member consumers with a list of the points of sale, of the goods and services sold in discounted form, and of the respective discount percentages established.

9. A method according to claim 1, in which the purchase is made on the internet.
